(19) United States
(12) Patent Application Publication
(10) Pub. No.: US 2025/0003731 A1
(43) Pub. Date: Jan. 2, 2025

(54) METHOD FOR QUANTITATIVE EVALUATION OF CONTACT LENS EDGE LIFT BASED ON OCT IMAGES

(71) Applicant: Alcon Inc., Fribourg (CH)

(72) Inventors: Yeming Gu, Suwanee, GA (US); Yan Wang, Carlsbad, CA (US); Seyedhadi Hosseini, Buford, GA (US)

(21) Appl. No.: 18/756,400

(22) Filed: Jun. 27, 2024

Related U.S. Application Data
(60) Provisional application No. 63/510,761, filed on Jun. 28, 2023.

(51) Int. Cl. G01B 9/02091; G01B 11/24; G02C 7/02

(52) U.S. Cl. CPC G01B 9/02091; G01B 11/2441; G02C 7/027

(57) ABSTRACT

A method for quantitively evaluating contact lens edge lift and distortion. The method includes the steps of scanning an edge of a contact lens, modeling the edge profile, determining a best-fit line over the modeled edge profile, calculating the slope of the best-fit line at a contact lens edge point, and further calculating a slope edge angle (ESA) as a function of the slope, wherein the ESA is a highly effective metric for capturing the contact lens edge-lift relative to the intended shape of the lens. The method may be used to provide design feedback, predict clinical fitting outcomes, and for quality control purposes.

This application claims the benefits under 35 USC § 119 (e) of U.S. provisional application No. 63/510,761, filed on 28 Jun. 2023, incorporated by reference in its entirety.

### TECHNICAL FIELD

The present invention relates generally to the field of contact lenses, and more particularly to a method of quantitively evaluating contact lens edge lift based on optical coherence tomography (OCT) imaging.

### BACKGROUND

The exact shape of a contact lens, especially the shape of the lens edge, is important to on-eye fitting and comfort. Traditional methods for evaluating lens shape are typically crude and lack in details (such as various methods for measuring sag and base curve radius or base curve equivalent). Destructive methods such as lens cross-section are used to examine the details of lens edge distortion; however, such methods cannot provide true-form shape evaluations. Non-destructive cross-section imaging methods enabled by optical coherence tomography (OCT) technology have also been used, but such methods are used mostly for qualitative evaluation by visually determining features such as for example edge lift and/or edge bending and are not precise. For example, Full Lens OCT (FLO) may be used to capture full lens cross-section images and Lens Edge OCT (LEO) can be used to capture details of lens edges. The cross-section images from both FLO and LEO can be visually inspected for noticeable edge shape distortions, but these evaluations do not provide quantitative measurements.

Accordingly, it can be seen that needs exist for improvements to methods defining various edge distortions quantitatively and precisely with simplicity and practicality. It is to the provision of improvements to a method of evaluating contact lens edge distortion meeting these and other needs that the present invention is primarily directed.

### SUMMARY

Generally, the present invention provides a simple and practical method of quantitatively gauging edge shape distortion in general and lens edge lift in particular. The method includes measuring the lens edge and determining an edge slope angle (ESA) of the lens edge. The ESA is a highly effective metric for capturing the contact lens edge-lift relative to the intended shape of the lens. Variations of this metric defined over different ranges, or the difference between different ESA models, can capture edge shape distortion on different scale and in meaningful details. The evaluation method of the present invention, and the resulting metrics, can be used for example to provide design feedback for lens design iteration process, predict clinical fitting outcomes, as a tool for process investigation related to lens edge quality, and as a quality control metric for controlling edge lift.

In one aspect, the present invention relates to a method of evaluating a lens having a posterior surface, an anterior surface, and a central axis. The method includes the steps of (i) collecting or capturing an image of an edge of the lens; (ii) modeling a profile of the lens from the image; (iii) processing the model of the profile; and (iv) conducting a quantitative analysis of the profile model.

In some example embodiments, the method may further comprise the step of repeating the steps of the method at a plurality of points along the periphery of the lens. The method may still further comprise the step of generating a comprehensive diagram or graph including the results of the quantitative analysis conducted at each of the plurality of points. The points may be intermittently or equally spaced from one another, such as for example 15 degrees between one another.

In some example embodiments, the step of processing the model of the profile may comprise approximating a best-fit line for the profile model. The best-fit line may be defined by a linear or a polynomial function, such as for example a 3rd order polynomial function. In still other example embodiments, the step of conducting the quantitative analysis of the profile may comprise determining a slope edge angle, wherein the slope edge angle is a function of the slope of the best-fit line at the edge of the lens.

In some example embodiments, the image of the lens edge is collected with a scanning system. The scanning system may include an optical coherence tomographer and a cuvette for holding the lens. Preferably, the optical coherence tomographer is coaxially aligned to the lens and the optical coherence tomographer is configured to rotate about the central axis of the lens and capture images of the lens edge. In preferred embodiments, the optical coherence tomographer is a lens edge optical coherence tomographer.

In some example embodiments, the method may further comprise the step of correcting the image of the lens edge accounting for effects of a refractive index and/or aspect ratio. The step of modeling the profile of the lens may comprise modeling the profile of at least one of the anterior surface or the posterior surface of the lens.

In another aspect, the present invention relates to a system for determining quantitative measurements of a contact lens edge. In example embodiments, the system includes means for imaging a cross-sectional profile of the contact lens edge, means for determining a regression curve for the cross-sectional profile, and means for determining the quantitative measurements of the contact lens edge along a periphery of the contact lens.

In some example embodiments, the means for imaging the cross-sectional profile comprises an optical coherence tomographer. Moreover, the means for imaging the cross-sectional profile further may comprise a receptacle for temporarily holding the contact lens securely in place and the optical coherence tomographer may be configured to rotate relative to the contact lens. Still, the quantitative measurements may include edge slope angles for identifying edge distortion along the contact lens edge.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 illustrates a method for quantitatively evaluating edge characteristics of a contact lens according to an example embodiment of the present invention.

FIG. 2 is a schematic view of an imaging system configured for capturing cross-sectional scans of the contact lens according to the method of FIG. 1.

FIG. 3 is a schematic view illustrating the relative scale and orientation of an original frame of the cross-sectional scan, with and without correction for refractive index and aspect ratio.

FIG. 4 shows an example raw scan image of the lens edge obtained from the method of FIG. 1.

FIG. 5 illustrates an example orientation of a rotated frame relative to the original frame.

FIG. 6 illustrates an example set of intermittent positions at which scans are captured along a perimeter of the contact lens according to the method of FIG. 1.

FIG. 7 shows an example graph with a linear regression approximation of a base curve profile in an original frame, without correction, according to example embodiments of the present invention.

FIG. 8 shows an example graph with a polynomial regression approximation of a base curve profile in the original frame, without correction, according to example embodiments of the present invention.

FIG. 9 shows an example graph with a linear regression approximation of a base curve profile in an original frame, with refraction correction, according to example embodiments of the present invention.

FIG. 10 shows an example graph with a polynomial regression approximation of a base curve profile in the original frame, with refraction correction, according to example embodiments of the present invention.

FIG. 11 shows an example graph with a polynomial regression approximation of a base curve profile in a rotated frame according to example embodiments of the present invention.

FIG. 12 shows an example graph of polynomial regression lines representing the base curve along the periphery of the contact lens at 20-degree-intervals.

FIGS. 13-15 show example forms of scatter plots of ESA values of different types of contact lenses according to example embodiments of the present invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. Also, any use of the terms “about,” “approximately,” “substantially,” and/or “generally” are intended to mean the exact value or characteristic indicated, as well as close approximations that are understood by persons of ordinary skill in the art to be sufficiently close to the exact value or characteristic based on the context of the intended use and application. In addition, any methods described herein are not intended to be limited to the sequence of steps described but can be carried out in other sequences, unless expressly stated otherwise herein.

The present invention relates generally to a method for quantitatively defining and evaluating various edge distortions in contact lenses, such as for example edge lift and/or edge bending. The method includes the use of an imaging system to capture detailed cross-section images and/or profile measurements of the contact lens edge. The images and/or measurements are then used to determine specific edge distortion characteristics along the perimeter of the contact lens. The edge distortion characteristics are determined by specific functions that estimate or approximate the lens profile. More specifically, the edge distortion characteristics are determined from specific parameters of regression curves that best approximate the lens profile. While the functional forms can be applied to both base curve and front curve, the base curve is the most relevant for lens fitting on the eye.

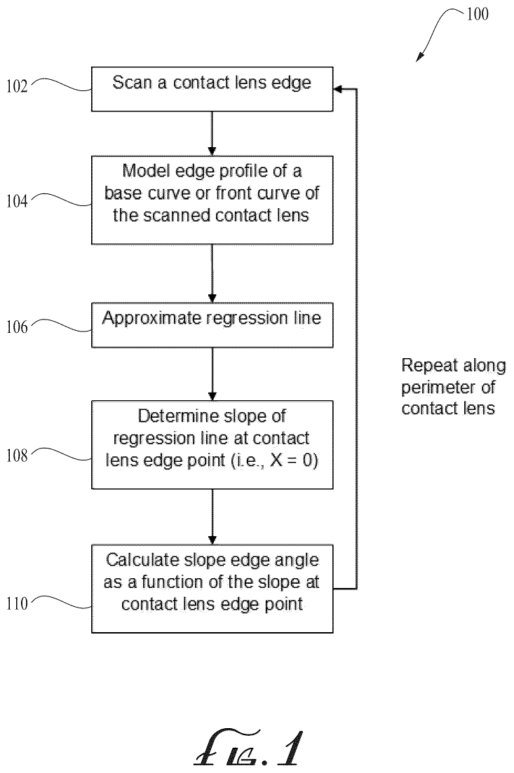

With reference now to the drawing figures, wherein like reference numbers represent corresponding parts throughout the several views, FIG. 1 illustrates a method for quantitively evaluating edge shape distortions of a contact lens according to example embodiments of the present invention. The method 100 generally comprises the steps of scanning the contact lens edge at 102, modeling the profile of at least one of the base curve or front curve of the contact lens at 104, approximating a best-fit or regression line for the modeled profile at 106, determining a slope of the regression line at the contact lens edge point at 108, and calculating an edge slope angle (ESA) as a function of the slope at the contact lens edge point at 110. The method 100 may be further repeated at intermittent points along the periphery of the contact lens to obtain a more complete realization or appreciation of the lens edge characteristics around the entirety of the contact lens.

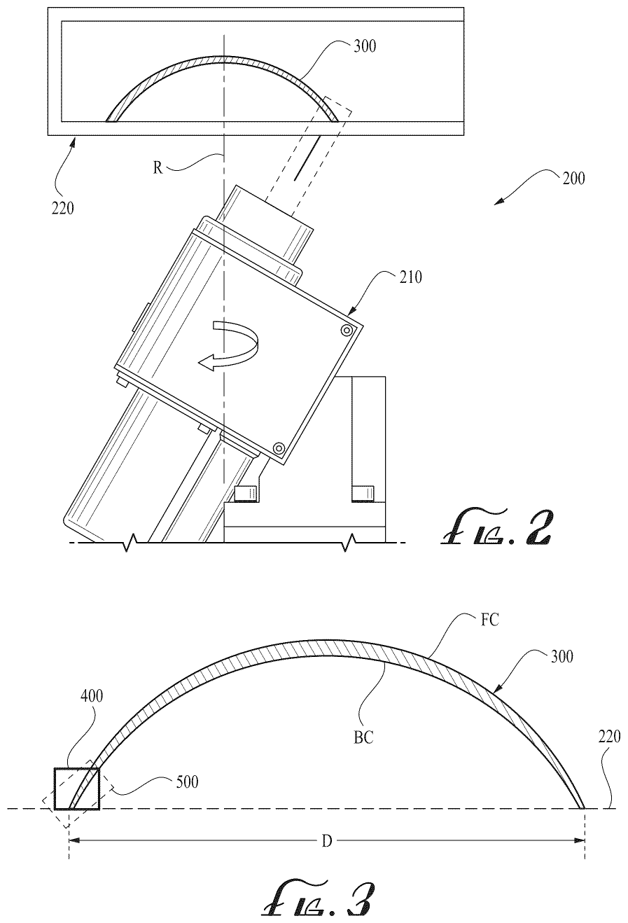

The contact lens edge evaluation method 100 starts at 102 with scanning a first point along an edge of the contact lens to capture a cross-section image of the edge. FIG. 2 shows a schematic view of a scanning/imaging system or arrangement 200 for capturing cross-section images of the contact lens edge according to example embodiments of the present invention. Generally, the imaging system 200 includes an imaging apparatus or device 210 and a receptacle or cuvette 220 for holding the test-subject contact lens 300 to be scanned and imaged. In example embodiments, the imaging device 210 is a lens edge optical coherence tomography (LEO) system. However, it should be appreciated that other suitable imaging devices, systems, and/or methods capable of capturing cross-section images of articles may be used, such as for example full lens OCT, topography, Purkinje imaging, and/or interferometry.

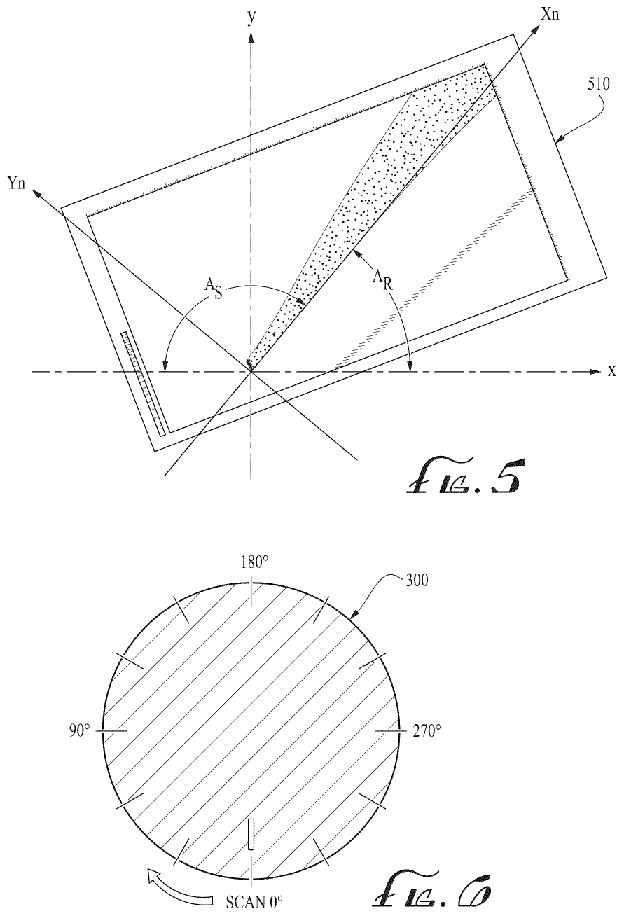

In example embodiments, the contact lens 300 is placed within or upon the cuvette 220 configured to hold the contact lens 300 stationary throughout the scanning process. As shown in FIG. 2, the scanning device 210 is configured or arranged to focus on the edge of the contact lens 300. The scanning device 210, or at least some portion thereof, may be further configured to rotate about a central or axial axis R of the contact lens 300 to capture images of the contact lens edge at a plurality of points along the periphery of the contact lens. For example, the scanning device 210 may be configured to rotate and scan the contact lens edge at intermittent intervals, such as for example about every 30 degrees along the periphery of the contact lens 300 (as shown in FIG. 6). In other example embodiments, scans may be taken at lesser or greater intervals around the periphery, or at any point or points as desired. In other example embodiments, the cuvette 220 may be configured to rotate along the central axis R while the scanning device 210 remains stationary.

According to example embodiments, method 100 continues, at 104, with modeling at least one of the base curve BC or front curve FC of the contact lens 300. As shown in FIG. 3, the base curve BC refers to a surface of the contact lens that faces towards the eye during wear whereas the front curve FC refers to a surface of the contact lens that faces away from the eye during wear. As noted above, the base curve BC is the most relevant for lens fitting on the eye. Accordingly, preferred embodiments of method 100 includes modeling the base curve BC only.

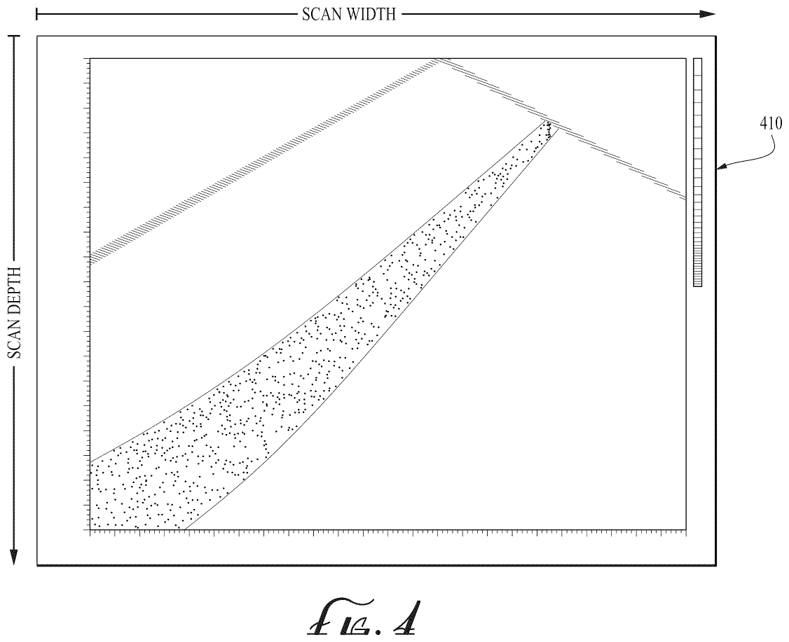

FIG. 4 shows an example raw cross-section image 410 of a contact lens edge captured using a LEO system. First outline or border 400 (as shown in FIG. 3) illustrates the orientation and size of the scanned image 410 relative to the contact lens 300. Preferably, the cross-section image will clearly show the cross-section profile of the contact lens, including at least one of the base curve or front curve. In example embodiments, the raw cross-section image includes a scan width and a scan depth. In preferred example embodiments, the scan depth and scan width range between about less than 1 mm to about 2 mm for a contact lens having a diameter D of about 14.5 mm. Initial observations have shown that this range of scan depth and scan width of the lens edge can be well described by 3^{rd} order polynomial functions as discussed in greater detail below. Still, the scanning system 200 may be reconfigurable to accommodate different scan widths and/or scan depths as desired or required.

In example embodiments, the raw cross-section image of the lens edge profile is plotted and shown in a X-Y plane or coordinate system. Where the base curve BC is used for the lens edge evaluation, the raw image is manipulated or oriented so that the contact lens edge point of the base curve BC is affixed to an origin (i.e., (0,0)) of the x-y coordinate system and the profile of the cuvette 220 is aligned to the x-axis, as shown in FIG. 5. On the other hand, if the front curve FC profile is the focus of the lens edge evaluation, the raw image should be manipulated so that the contact lens edge point of the front curve FC is affixed to the origin and the profile of the cuvette is configured to be parallel to the x-axis.

Second outline or border 500 (as shown in FIG. 3) illustrates the orientation and size of a corrected image 510 relative to the contact lens 300 and the first outline 400. According to preferred example embodiments, the raw scan image 410 is further processed or corrected to account for any refractive index and/or aspect ratio bias from the imaging device 210 and/or cuvette 220. More specifically, a 2D cross-section image from any OCT system is made up of many axial scans (A-scans). Each A-scan captures interferometric signal (intensity or brightness of image pixels) along the optical path of the laser beam, making up one column of the cross-section image. Therefore, in the vertical direction (depth or Y-axis), the pixel length or distance between two consecutive pixels, is the optical-path-distance, which equals to the geometrical distance multiplied by the index of refraction. Furthermore, the geometric distance is measured along the direction of the laser beam, which changes when the laser beam passes through any optical surface, as dictated by the law of optical refraction. This has two implications to the OCT image:
(i) the vertical scale of the image differs from true geometric scale by factor equal to the index of refraction; and
(ii) if there are one or more optical surfaces in the image, the portion of the image beyond each surface is distorted due to the directional change of the laser beam.
   These two factors result in a distorted image of the true geometric shape of the object. In order to measure the true geometric shape of an object within an OCT image, the image has to be corrected using the optical ray-tracing method. This corrective process is commonly known as refractive correction. In example embodiments, processing the raw scan image 410 through refractive correction results in the corrected scan image 510.

Subsequently, method 100 continues at 106 with approximating a best-fitting or regression line for the base curve (or front curve) profile model acquired at 104. In example embodiments, the base curve profile model is defined by a best-fit polynomial curve for the detected base curve profile based on the captured cross-section image. Where the ideal shape of the contact lens base curve is near-spherical, the radius of curvature is near-constant at all points along the base curve. As such, any small section of the base curve profile of an ideal contact lens should closely fit a 2^{nd} order polynomial curve. However, contact lenses typically suffer from various edge distortions, such as for example edge lift or bending, which generally corresponds to the base curve bending outwards, resulting in significant deviation from the 2^{nd} order curve. Significant edge lift will also correspond to a sign change in the radius of curvature along the base curve profile near the edge. It has been observed that a small segment of the base curve BC profile (<1-2 mm) can be well described by 3^{rd} order polynomial functions. While a typical “edge lift” can be well-fitted with a 3^{rd} order curve, higher order curves can be used to capture more complex shape variations.

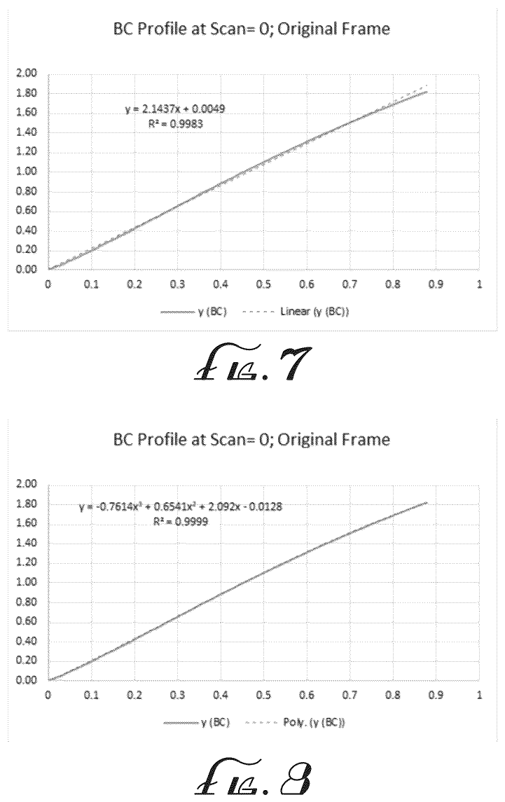

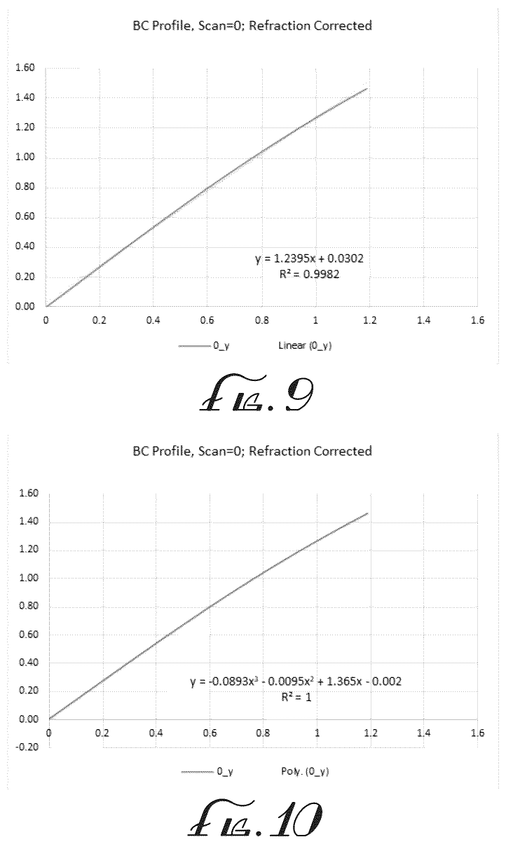

For example, FIG. 7 illustrates a 1^{st} order (linear) regression curve (shown in dashed line) for the base curve profile (shown in solid line). FIG. 8, on the other hand, illustrates a 3^{rd} order regression curve for the same base curve profile. As shown visually, and further appreciated by the r-square value, the 3^{rd} order regression curve fits the base curve profile more precisely and closely than the 1^{st} order regression curve. Similarly, FIGS. 9 and 10 illustrate the 1^{st} and 3^{rd} order regression curves for the same base curve profiles with corrections for refraction.

Method 100 continues at 108 with determining a slope of the regression curve at the contact lens edge point (i.e., where x=0). It should be appreciated that the slope m of any N-th order polynomial curve is equal to the 1^{st} order coefficient, C₁, at the contact lens edge point (i.e., where x=0).

$$y = {C}_{N} {x}^{N} + {C}_{N - 1} {x}^{N - 1} + … + {C}_{1} x + {C}_{0}$$

$$m ( x = 0 ) = {C}_{1}$$

Method 100, at 110, includes calculating a edge slope angle (ESA or As) as a function of the slope m at the contact lens edge point.

$${A}_{S} ( x = 0 ) = 180 - atan ( m )$$

The ESA is a simple but highly effective metric for capturing the contact lens edge-lift relative to the intended shape of the lens. Variations of this metric defined over different range, or the difference between different ESA models, can capture edge shape distortion on different scale and in meaningful details. In particular, the ESA can be defined by the tangent of the modeled base curve profile at the edge point. Different ESA can be defined on a pre-defined range for best-fit model and by the order of the polynomial function. Varying the range and the order of the model allows the resulting ESA metric to capture different level of details in edge shape. For a given range, defined by the maximum distance from the edge point, different ESA can be defined for the 1^{st} order polynomial (straight line fit), 2^{nd} order, 3^{rd} order, and so on. For a contact lens with a typical edge lift and without small scale distortions, the edge lift is best captured by the ESA based on the 3^{rd} order model in a range of about 0.5 to 2 mm.

ESA calculations based on the example regression curves presented in FIGS. 7-10 will now be presented. Referring first to FIG. 7, the best-fit 1^{st} order function for the BC curve is defined by the following function:

$$y = 2.1437 x + 0.0049$$

Accordingly, the tangent or slope of the modeled base curve profile at the edge point is defined by the first order coefficient, 2.1437, and the ESA (in degrees) may be calculated as follows:

$$\begin{matrix}{A}_{S} ( x = 0 ) = 180 - a tan ( 2.1437 ) \\ {A}_{S} ( x = 0 ) = 180 - 65.00 \\ {A}_{S} ( x = 0 ) = 115. 00\end{matrix}$$

Referring now to FIG. 8, the best-fit 3^{rd} order function for the BC curve is defined as:

$$y = - 0.7614 {x}^{3} + 0.6541 {x}^{2} + 2.092 x + 0.0128$$

Accordingly, the tangent or slope of the modeled base curve profile at the edge point is defined by the first order coefficient, 2.092, and the ESA (in degrees) may be calculated as follows:

$$\begin{matrix}{A}_{S} ( x = 0 ) = 180 - a tan ( 2.092 ) \\ {A}_{S} ( x = 0 ) = 180 - 64.45 \\ {A}_{S} ( x = 0 ) = 115.55\end{matrix}$$

As noted above, FIGS. 9 and 10 illustrate the regression functions for BC profile with refraction corrected data, wherein the 1^{st} order regression function is defined by

$$y = 1.2395 x + 0.0302$$

and the 3^{rd} order regression function is defined by

$$y = - 0.0893 {x}^{3} + 0.0095 {x}^{2} + 1.365 x + 0.002$$

Accordingly, the ESA for the refraction corrected profile model can be calculated as follows:

$$\begin{matrix}{A}_{S} ( {x}_{0} , n 1 ) = 180 - a tan ( 1.2395 ) = 128.9 \\ {A}_{S} ( {x}_{0} , n 3 ) = 180 - a tan ( 1.365 ) = 126.2\end{matrix}$$

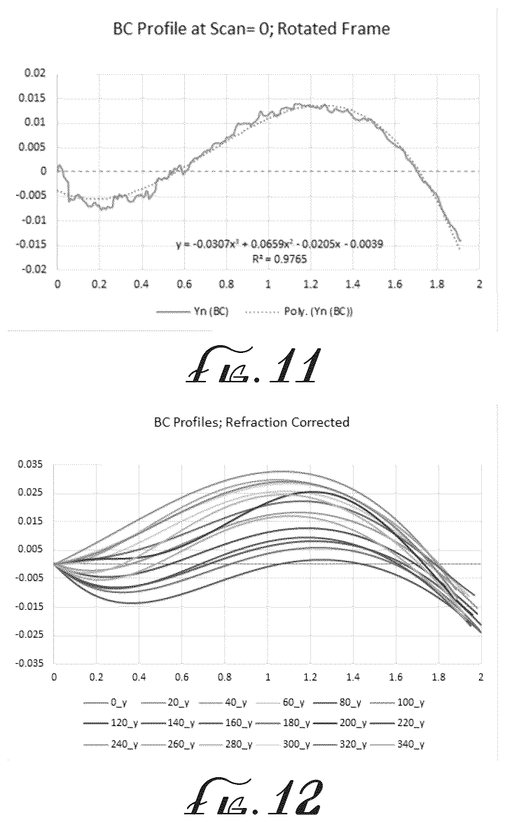

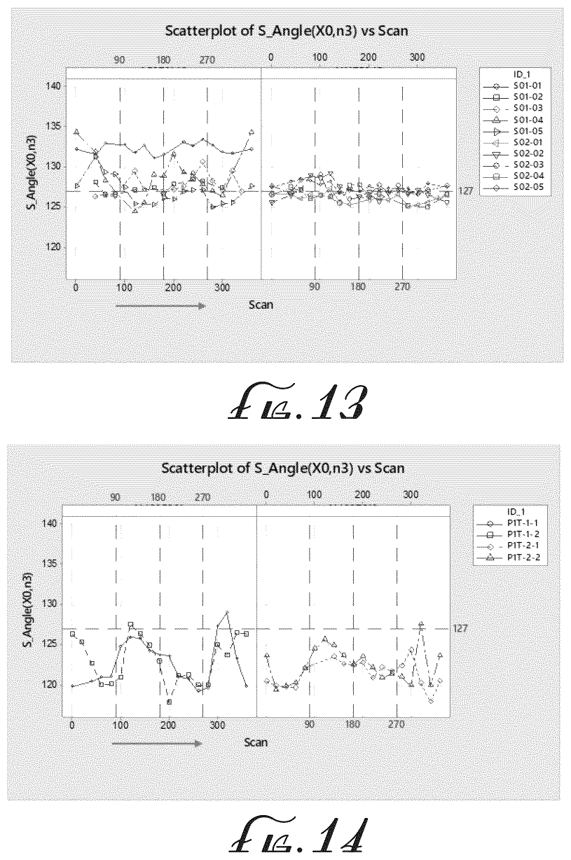

According to example embodiments of the present invention, the lens edge shape can be further evaluated for additional detail by modifying the coordinate system in which the lens curve profile is plotted and measured. For example, FIG. 5 shows a rotated Xn-Yn coordinate system wherein the original x-y coordinate system is rotated by angle A_{R} so that the linear best-fit line for the lens curve profile becomes the Xn axis of the rotated coordinate system. FIG. 11 shows an example graph with a 3^{rd} order regression approximation of a base curve profile in a rotated frame according to example embodiments of the present invention. As shown in FIG. 11, analyzing the base curve on the rotated frame or coordinate system provides a simpler visualization of the BC shape. Indeed, the fact that the BC is well defined by a 3^{rd} order polynomial function provides evidence for edge lift-whereas a 2^{nd} order curve is expected for a perfect lens with near-spherical BC. For a more comprehensive and complete visual analysis of the lens edge shape of the entire lens edge, regression curves for the lens edge profile at a plurality of points along the periphery of the contact lens can be plotted in a single graph, for example, as shown in FIG. 12. FIG. 12 shows an example graph of polynomial regression lines representing the base curve along the periphery of the contact lens at 20-degree intervals.

In example embodiments, method 100 may be repeated at a plurality of points along the periphery of the contact lens. FIG. 6 illustrates an example layout of scan points at 30-degree intervals. Determining the edge shape angles at intermittent points along the periphery of the contact lens provides a more comprehensive and meaningful quantitative evaluation of the contact lens as a whole.

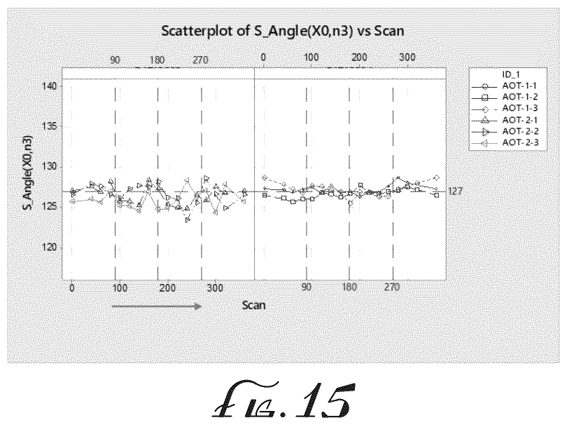

FIGS. 13-15 show scatterplots of ESA values determined along the periphery of various types of lenses according to prior observations. For example, FIG. 13 shows a scatterplot of ESA values along the periphery of various worn and unworn commercially available Alcon brand sphere lenses. As expected for sphere lenses, which have axial symmetry by design, FIG. 13 shows no distinctive peaks. FIG. 14 shows a scatterplot of ESA values for commercially available Alcon brand toric lenses. The characteristic peaks at 180 degrees are due to the particular material property and correlated with the edge thickness variation greater than about 500 μm from the edge. FIG. 15 shows a scatterplot of ESA values for another commercially available Alcon brand toric lenses.

While the invention has been described with reference to example embodiments, it will be understood by those skilled in the art that a variety of modifications, additions and deletions are within the scope of the invention, as defined by the following claims.

What is claimed is:

1. A method of evaluating a lens having a posterior surface, an anterior surface, and an axial axis, the method comprising the steps of:
collecting an image of an edge of the lens;
modeling a profile of the lens from the image;
processing the model of the profile; and
conducting a quantitative analysis of the profile.

2. The method of claim 1, further comprising the step of repeating the steps of the method at a plurality of points along the periphery of the lens.

3. The method of claim 2, further comprising the step of generating a comprehensive diagram including the results of the quantitative analysis conducted at the plurality of points.

4. The method of claim 3, wherein the points are equally spaced from one another.

5. The method of claim 4, wherein the points are spaced about 15 degrees apart.

6. The method of claim 1, wherein the step of processing the model of the profile comprises approximating a best-fit line for the profile.

7. The method of claim 6, wherein the best-fit line is defined by a linear function.

8. The method of claim 6, wherein the best-fit line is defined by a polynomial function.

9. The method of claim 8, wherein the best-fit line is defined by a third-order polynomial function.

10. The method of claim 8, wherein the step of conducting the quantitative analysis of the profile comprises determining a slope edge angle.

11. The method of claim 10, wherein the slope edge angle is a function of the slope of the best-fit line at the edge of the lens.

12. The method of claim 1, wherein the image of the edge of the lens is collected with a scanning system.

13. The method of claim 12, wherein the scanning system comprises an optical coherence tomographer and a cuvette for holding the lens, wherein the optical coherence tomographer is coaxially aligned to the lens and the optical coherence tomographer is configured to rotate about the axial axis of the lens and capture images of the edge of the lens.

14. The method of claim 13, wherein the optical coherence tomographer is a lens edge optical coherence tomographer.

15. The method of claim 14, further comprising the step of correcting the image of the edge of the lens accounting for effects of refractive index and aspect ratio.

16. The method of claim 1, wherein the step of modeling the profile of the lens comprises modeling the profile of at least one of the base curve surface or the front curve surface of the lens.

17. A system for determining quantitative measurements of a contact lens edge, comprising:
means for imaging a cross-sectional profile of the contact lens edge;
means for determining a regression curve for the cross-sectional profile; and
means for determining the quantitative measurements of the contact lens edge along a periphery of the contact lens.

18. The system of claim 17, wherein the means for imaging the cross-sectional profile comprises an optical coherence tomographer.

19. The system of claim 18, wherein the means for imaging the cross-sectional profile further comprises a receptacle for temporarily holding the contact lens securely in place and the optical coherence tomographer is configured to rotate relative to the contact lens.

20. The system of claim 17, wherein the quantitative measurements comprise edge slope angles for identifying edge distortion along the contact lens edge.
